(19) United States
(12) Patent Application Publication
(10) Pub. No.: US 2013/0302497 A1
(43) Pub. Date: Nov. 14, 2013

(54) Taste Enhancement

(71) Applicants: Tarun Bhowmik, Mason, OH (US); Yili Wang, Mason, OH (US); Pablo Victor Krawec, Cincinnati, OH (US)

(72) Inventors: Tarun Bhowmik, Mason, OH (US); Yili Wang, Mason, OH (US); Pablo Victor Krawec, Cincinnati, OH (US)

(73) Assignee: Givaudan S.A., Vemier (CH)

(21) Appl. No.: 13/822,023

(22) PCT Filed: Sep. 13, 2011
(86) PCT No.: PCT/EP2011/065882

§ 371 Date: Apr. 2, 2013

Related U.S. Application Data
(60) Provisional application No. 61/382,083, filed on Sep. 13, 2010.

(51) Int. Cl. A23L 1/22

(52) U.S. Cl. CPC A23L 1/22091
USPC 426/534; 426/442

(57) ABSTRACT

A method of enhancing a taste sensation in a consumable composition, comprising the addition thereto of a taste provider selected from a taste provider compound and a mixture of a taste provider compound with a taste enhancement compound, there being additionally added thereto a taste sensation-enhancing quantity of choline chloride.

This disclosure relates to taste enhancement.

There is often a desire to increase certain taste sensations in consumable compositions without increasing, and possibly even decreasing, the quantity of substance providing the particular taste sensation (hereinafter “taste provider”). Thus, if the sweetness of a consumable composition can be increased, it may be possible to decrease the quantity of the taste provider that is added. For example, a decrease in the quantity of added sugar as a taste provider is often an important dietary consideration. Similarly, if saltiness can be enhanced, while simultaneously reducing the quantity of the taste provider salt, this can also bring important health benefits. A further taste sensation is umami, the flavour found in many Asian dishes and which is commonly produced by the addition of taste provider monosodium glutamate (MSG). Many consider it desirable to reduce the quantity of MSG, but wish to retain the same umami flavour.

Taste sensations can be enhanced in two ways. One is to add materials that inherently have the desired flavour but that lack the undesirable qualities of the taste providers. These can be total or partial replacements.

The other way is to add taste enhancers, that is, materials that do not themselves contribute any of the desired taste sensation, but which accentuate the sensation, thereby enabling a reduction of the taste provider, while maintaining the same level of taste sensation. Such materials may themselves be taste providers, but used at a level below the threshold level at which they exert their particular taste effect. For example, some sweetener molecules used at a low level have been found to enhance considerably the sweetness of sugar. Alternatively, there are compounds that are inherently lacking in taste sensation provision, but whose presence accentuates the taste sensation of taste providers. The mechanism by which these compounds function is not clear. It is believed, without limiting this disclosure to any mechanism, that the substances interact with the appropriate taste receptors in the mouth, to provide an enhanced taste perception.

It has now been surprisingly found that the addition of a particular substance to a taste provider can reinforce its effect, sometimes considerably. There is therefore provided a method of enhancing a taste sensation in a consumable composition, comprising the addition thereto of a taste provider selected from a taste provider compound and a mixture of a taste provider compound with a taste enhancement compound, there being additionally added thereto a taste sensation-enhancing quantity of choline chloride.

In a particular embodiment, there is provided a method of enhancing sweetness sensation in a consumable product, comprising the addition thereto of a sweetness provider selected from a sweetness-providing compound and a mixture thereof with a sweetness-enhancing compound, there being additionally added thereto a sweetness sensation-enhancing quantity of choline chloride.

In a further particular embodiment, there is provided a method of enhancing saltiness sensation in a consumable product, comprising the addition thereto of a saltiness provider selected from a saltiness-providing compound and a mixture thereof with a saltiness-enhancing compound, there being additionally added thereto a saltiness sensation-enhancing quantity of choline chloride.

In a further particular embodiment, there is provided a method of enhancing umami sensation in a consumable product, comprising the addition thereto of a umami provider selected from a umami-providing compound and a mixture thereof with a umami-enhancing compound, there being additionally added thereto a umami sensation-enhancing quantity of choline chloride.

There is additionally provided a taste sensation-enhancing composition comprising a taste-enhancing compound and choline chloride.

In a further particular embodiment, the taste sensation is selected from sweetness, saltiness and umami.

The use of the singular in this description also includes the plural, that is, the expression “a sweetness-providing compound” includes the presence of two or more such compounds.

Choline is a compound found in nature in a variety of sources, including beef, beef liver, eggs, cauliflower, navy beans, tofu and nuts. Its presence in the body is essential to life, and it is widely available as a nutritional supplement. It is on the GRAS (General Recognised As Safe) list of the US FDA.

Choline is used in the method of this disclosure in the form of its chloride salt. The choline used may be the pure synthesised compound, made typically by the reaction of 2-chloroethanol with triethylamine. Alternatively, it may be derived from natural sources, for example, from natural soybean, canola, rice, seafood, or chicken skin, which are rich in choline or phosphotidyl choline, by any convenient means, such as physical methods (such as extraction, distillation, or similar methods) or chemical methods (such as fermentation, enzymatic treatment or similar methods). The chloride is then made by reaction with, for example, hydrochloric acid, lysine hydrochloride or arginine hydrochloride. The resulting choline chloride may be purified, but in many cases it may be used in the form of the reaction mixture.

The taste-providing compounds may be selected from any of the wide range of such compounds known to the art. Non-limiting examples of suitable compounds include:

Sweet:

Sucrose, fructose (e.g., D-fructose), glucose (e.g., D-glucose), and sweetener compositions comprising natural sugars, such as corn syrup (including high fructose corn syrup) or other syrups or sweetener concentrates derived from natural fruit and vegetable sources, semi-synthetic “sugar alcohol” sweeteners such as erythritol, isomalt, lactitol, mannitol, sorbitol, xylitol, maltodextrin, glycerol, threitol, arabitol, ribitol, dulcitol, and the like, and artificial sweeteners such as miraculin, aspartame, superaspartame, saccharin, saccharin-sodium salt, acesulfame-K, cyclamate, sodium cyclamate, and alitame. Sweeteners also include trehalose, melizitose, melibiose, raffinose, palatinose, lactulose, cyclamic acid, mogroside, tagatose (e.g., D-tagatose), maltose, galactose (e.g., D-galactose), L-rhamnose, D-sorbose, mannose (e.g., D-mannose), lactose, L-arabinose, D-ribose, D-glyceraldehyde, curculin, brazzein, Neohesperidin dihydrochalcone (NHDC), neotame and other aspartame derivatives, D-tryptophan, D-leucine, D-threonine, glycine, D-asparagine, D-phenylalanine, L-proline, maltitol, hydrogenated glucose syrup (HGS), magap, sucralose, lugduname, sucrononate, sucrooctate, monatin, trilobatin, Hesperetin Dihydrochalcone 4′-β-D-glucoside, phyllodulcin, hydrogenated starch hydrolyzate (HSH), stevioside, rebaudioside A and other sweet Stevia-based glycosides, Io han guo, thaumatin, monellin, carrelame and other guanidine-based sweeteners.

Other examples of sweet compounds include compounds including salts thereof, of the formula I:

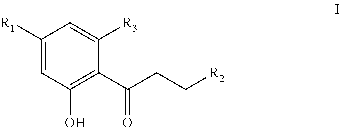

wherein R₁ comprises H, OH, or

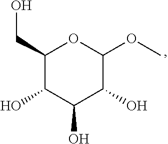

wherein R₂ comprises

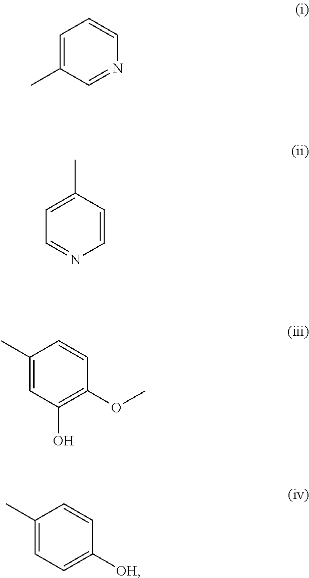

and wherein R₃ comprises H or OH.

The compounds of Formula I are described in United States Patent Publication US 2010/0040753 A1, the contents of which are hereby incorporated herein by reference.

Salt:

Sodium chloride and potassium chloride.

Umami:

MSG, (E)-N-(3,7-dimethylocta-2,6-dienyl)cyclopropanecarboxamide, N-(2-methoxy-4-methylbenzyl)-N′-(2-(pyridin-2-yl)ethyl)oxalamide, N-(2-methoxy-4-methylbenzyl)-N′-(2-(5-methyl-pyridin-2-yl)-ethyl)oxalamide, N-(2,4-dimethoxy-benzyl)-N′-(2-(pyridin-2-yl)ethyl)oxalamide, compounds (including salts thereof) according to Formula II

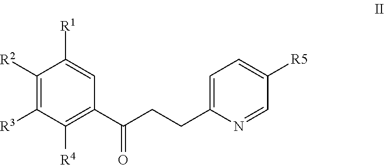

in which

R¹ is selected from H or methyl;

R² is selected from H, OH, fluorine, C₁-C₂ alkyl, or C₁-C₆ alkoxy wherein the alkyl group is linear or branched;

R³ is selected from H or methyl;

or R² and R³ together form a bridging moiety —O—CH₂—O— between the phenyl carbon atoms to which they are connected;

R⁴ is OH; and

R⁵ is selected from H and methyl;

R¹, R², R³, R⁴ and R⁵ being selected such that,

(i) when R² and R³ together form a bridging moiety —O—CH₂—O— between the phenyl carbon atoms to which they are connected, R¹ and R⁵ are H, and R⁴ is OH; and

(ii) when R⁴ is OH, R¹-R³ are H and R⁵ is methyl, or R¹ and R³ are methyl, and R² and R⁵ are H.

Suitable non-limiting examples of salts of the above identified compounds include K⁺, NH₄⁺, Na⁺, Ca²⁺, Mg²⁺, Al³⁺, Zn²⁺, hydrochloride and hydrobromide.

Such compounds are described in International Patent Application PCT/EP2010/059916, the contents whereof are herein incorporated by reference.

Particular examples of the compounds of Formula II include:

1-(2-hydroxy-4-methylphenyl)-3-(pyridine-2-yl)propan-1-one;

1-(2-hydroxy-4-methoxylphenyl)-3-(pyridine-2-yl)propan-1-one;

1-(2-hydroxy-4-isobutoxyphenyl)-3-(pyridine-2-yl)propan-1-one;

1-(2-hydroxy-4,5-dimethylphenyl)-3-(pyridine-2-yl)propan-1-one; and

1-(2-hydroxy-4-(pentyloxy)phenyl)-3-(pyridine-2-yl)propan-1-one.

The taste-enhancing compounds may be selected from any such compounds known to the art. Non-limiting examples of these include:

Sweetness-Enhancing:

1-(2-hydroxyphenyl)-3-(pyridine-4-yl)propan-1-one, trilobatin and Hesperetin dihydrochalcone 4′-β-D glucoside (HDG).

Salt Enhancing:

(E)-N-(3,7-dimethylocta-2,6-dienyl)cyclopropanecarboxamide, 1-(2-hydroxy-4-(pentyloxy)phenyl)-3-(pyridine-2-yl)propan-1-one and 1-(2-hydroxy-4-isobutoxyphenyl)-3-(pyridine-2-yl)propan-1-one.

Umami Enhancing:

1-(2-hydroxy-4-methoxylphenyl)-3-(pyridine-2-yl)propan-1-one, 1-(2-hydroxy-4-isobutoxyphenyl)-3-(pyridine-2-yl)propan-1-one and ribonucleotides.

There is further provided a taste-enhanced consumable composition, comprising a consumable composition base and a taste provider selected from a taste provider compound and a mixture of a taste provider compound with a taste enhancement compound, additionally comprising a taste sensation-enhancing quantity of a choline salt.

By “consumable composition” is meant any composition that is consumed orally, whether for ingestion or for purely oral use followed by spitting or rinsing out. This includes not only foodstuffs and beverages of all kinds, but also mouthwashes, toothpastes, salves and the like.

By “consumable composition base” is meant the totality of all the ingredients needed to provide a consumable composition, except for those added to provide taste. These will differ according to the nature of the consumable composition, but the skilled person will be readily able to select appropriate ingredients in each case, using only the ordinary skill of the art.

Specific and non-limiting examples of consumable compositions include:

All food products, food additives, nutraceuticals, pharmaceuticals and any product placed in the mouth including chewing gum, oral care products, and oral hygiene products including but not limited to, cereal products, rice products, tapioca products, sago products, baker's products, biscuit products, pastry products, bread products, confectionery products, dessert products, gums, chewing gums, flavored or flavor-coated straws, flavor or flavor-coated food/beverage containers, chocolates, ices, honey products, treacle products, yeast products, baking-powder, salt and spice products, savoury products, soups, mustard products, vinegar products, sauces (condiments), tobacco products, cigars, cigarettes, processed foods, cooked fruits and vegetable products, meat and meat products, jellies, jams, fruit sauces, egg products, milk and dairy products, yoghurts, cheese products, butter and butter substitute products, milk substitute products, soy products, edible oils and fat products, medicaments, beverages, carbonated beverages, alcoholic drinks such as beers, wines and spirits, non-alcoholic drinks such as soft drinks, mineral and aerated waters, fruit drinks, fruit juices, coffee, artificial coffee, tea, cocoa, including forms requiring reconstitution including, without limitation, beverage powder, milk based beverage powder, sugar-free beverage powder, beverage syrup, beverage concentrate, instant coffee, instant tea, instant cocoa, and coffee whitener, food extracts, plant extracts, meat extracts, condiments, gelatins, pharmaceutical and non-pharmaceutical gums, tablets, lozenges, drops, emulsions, elixirs, syrups and other preparations for making beverages, and combinations thereof.

Oral care products, including, but not limited to, any composition applied to the oral cavity for the purposes of cleaning, freshening, healing, deodorising the cavity or any part thereof, may include, but are not limited to, toothpastes, tooth gels, tooth powders, tooth whitening products, mouthwashes, lozenges, dental floss, toothpicks, anti-plaque and anti-gingivitis compositions, throat lozenges, throat drops, inflammatory compositions, compositions for treatment of nasal symptoms, cold symptoms and upper gastrointestinal tract distress, compositions for cold relief, for alleviating discomfort of hot flash, and gargle compositions.

The proportions of choline chloride used will vary according to the use and to the particular effect desired, but, as a general rule, the proportion may be between 0.1 and 100 ppm, more particularly between 1 and 10 ppm. This does not exclude the possibility that a flavorist may use proportions outside these limits in certain cases.

The description is further exemplified by the following non-limiting examples.

### EXAMPLE 1

Umami/Salty:

The materials described below were evaluated at the concentration specified by an expert panel in a chicken broth (commercial Swanson chicken broth, with no MSG added, 50% reduced sodium 430 mg/serving) with or without added choline chloride (7 ppm final concentration).

The following results were obtained:
a) 1-(2-hydroxy-4-methoxyphenyl)-3-(pyridin-2-yl)propan-1-one:
   Concentration (10 ppm): Umami, lingering, body.
   With choline added: enhancement of umami, enhancement of saltiness.
b) 1-(2-hydroxy-4,5-dimethylphenyl)-3-(pyridin-2-yl)propan-1-one:
   Concentration (10 ppm): Weak umami.
   With choline added: Better, stronger umami, saltier.
c) (E)-N-(3,7-dimethylocta-2,6-dienyl)cyclopropanecarboxamide:
Concentration (2 ppm): Umami, salty, not good aftertaste.
   With added choline: Very full, more salty, umami.
d) N-(2-methoxy-4-methylbenzyl)-N′-(2-(pyridin-2-yl)ethyl)oxalamide:
   Concentration (0.5 ppm) : lingering umami.
   With added choline: more lingering umami, kokumi.
e) 1-(2-hydroxy-4-isobutoxyphenyl)-3-(pyridine-2-yl)propan-1-one
   Concentration (1 ppm): Salty and umami
   With added chloline: enhanced the saltiness and umami character with a well rounded taste profile.
g) 1-(2-hydroxy-4-(pentyloxy)phenyl)-3-(pyridine-2-yl)propan-1-one
   Concentration (1 ppm): salty and umami
   With added choline: enhanced the saltiness and umami character with a well rounded taste profile.

### EXAMPLE 2

Sweetness:

The materials described below were evaluated at the specified concentration in a base composed of rebaudioside A (300 ppm), and citric acid (300 ppm) in water. Each chemical was evaluated with and without the addition of choline (7 ppm final concentration).

a) 1-(2-hydroxyphenyl)-3-(pyridine-4-yl)propan-1-one at a concentration of 1 ppm.

b) Trilobatin at a concentration of 50 and 100 ppm.

In all cases, addition of choline enhanced sweetness.

Although the embodiments have been described in detail through the above description and the preceding examples, these examples are for the purpose of illustration only and it is understood that variations and modifications can be made by one skilled in the art without departing from the scope of the disclosure. It should be understood that the embodiments described above are not only in the alternative, but can be combined.

1. A method of enhancing a taste sensation in a consumable composition, comprising the addition thereto of a taste provider selected from a taste provider compound and a mixture of a taste provider compound with a taste enhancement compound, there being additionally added thereto a taste sensation-enhancing quantity of choline chloride.

2. A method according to claim 1, in which the taste sensation is selected from sweetness, saltiness and umami.

3. A method of enhancing a taste sensation according to claim 1, in which the taste sensation is sweetness, comprising the addition thereto of a sweetness provider selected from a sweetness-providing compound and a mixture thereof with a sweetness-enhancing compound, there being additionally added thereto a sweetness sensation-enhancing quantity of choline chloride.

4. A method of enhancing a taste sensation according to claim 1, in which the taste sensation is saltiness, comprising the addition thereto of a saltiness provider selected from a saltiness-providing compound and a mixture thereof with a saltiness-enhancing compound, there being additionally added thereto a saltiness sensation-enhancing quantity of choline chloride.

5. A method of enhancing a taste sensation according to claim 1, in which the taste sensation is umami, comprising the addition thereto of a umami provider selected from a umami-providing compound and a mixture thereof with a umami-enhancing compound, there being additionally added thereto a umami sensation-enhancing quantity of choline chloride.

6. A taste sensation-enhancing composition comprising a taste-enhancing compound and choline chloride.

7. A taste-enhanced consumable composition, comprising a consumable composition base and a taste provider selected from a taste provider compound and a mixture of a taste provider compound with a taste enhancement compound, additionally comprising a taste sensation-enhancing quantity of choline chloride.

8. A consumable composition according to claim 7, in which the choline chloride is present to the extent of from 0.1-100 ppm.
